(19) United States
(12) Patent Application Publication
(10) Pub. No.: US 2025/0115790 A1
(43) Pub. Date: Apr. 10, 2025

(54) ADHESIVE CONSTRUCTURES AND MANUFACTURING METHOD THEREOF

(71) Applicant: FOUNDATION FOR RESEARCH AND BUSINESS, SEOUL NATIONAL UNIV. SCIENCE AND TECH., Seoul (KR)

(72) Inventors: Hyunsik YOON, Seoul (KR); Hye Min Lee, Seoul (KR); Ye Rin Ryu, Seoul (KR)

(73) Assignee: FOUNDATION FOR RESEARCH AND BUSINESS, SEOUL NATIONAL UNIV. SCIENCE AND TECH., Seoul (KR)

(21) Appl. No.: 18/904,389

(22) Filed: Oct. 2, 2024

(30) Foreign Application Priority Data
Oct. 4, 2023 (KR) 10-2023-0131717

(51) Int. Cl. C09J 7/32; C09J 7/35

(52) U.S. Cl. CPC C09J 7/32; C09J 7/35; C09J 2301/204; C09J 2301/31

(57) ABSTRACT

The present disclosure provides an adhesive constructure including: a substrate and a hollow structure disposed to protrude on the substrate, wherein the hollow structure includes a hollow support portion protruding from the substrate and fixed on the substrate and an adhesive portion disposed below the hollow support portion and exposed to the outside, and the adhesive portion has a larger swelling ratio than the hollow support portion and the adhesive portion has a hollow horn shape of which volume expands in a wet state.

### TECHNICAL FIELD

The present disclosure relates to an adhesive constructure and a method for manufacturing the same.

### BACKGROUND ART

Biological organisms have been a source of a number of studies on adhesion means. Examples thereof include a gecko foot capable of providing adhesion force in a dry environment and an octopus suction cup capable of providing adhesion force in a wet environment. After understanding principles of such unique structures, many researchers have tried to produce artificial adhesion means, and utilized these in a wide range of applications such as adhesion means, transfer machines, bio-patches and wearable devices.

A dry adhesion means using a gecko foot is characterized by the use of van der Waals force and a large contact area using millions of flexible and hierarchical hairs. However, the use of the dry adhesion means is limited in an aqueous condition, and this is due to the fact that van der Waals force is weakened due to water penetration between the dry adhesion means and a surface subject to adhesion. In other words, hydration layers are created between the adhesion means and the object in an aqueous condition, and van der Waals force is reduced by the hydration layers, weakening adhesion force between the dry adhesion means and the surface subject to adhesion.

As for wet adhesion means, there are two main approaches. The first approach involves chemical effects, using special proteins of marine organisms such as a mussel. The second approach involves physical effects of a wet adhesion means, utilizing an octopus suction cup that uses a pressure difference between outside and inside of the chamber. In particular, a structure with built-in protrusions exhibits strong adhesion force in wet and dry states.

However, wet adhesion means have a problem in that, although adhesion force is strong, detachment is difficult under water or in a moist environment.

Although studies on wet adhesion means have been in progress as described above, there are still needs for wet adhesion means that are readily detached, and capable of binding on a rough space and switching between adhesion and detachment. Devices capable of readily switching between adhesion and detachment may be used to move an object from one side to the other side as well as in locomotion in the field of soft robotics.

In other words, there are technical demands for adhesive constructures capable of controlling adhesion and detachment underwater or in a moist environment, and there are needs for studies on adhesive constructures capable of, using materials that actively respond to external stimuli, detachment without external force by an increase in elastic modulus and a decrease in wettability depending on environmental changes after adhesion.

### PRIOR ART DOCUMENTS

### Patent Documents

(Patent Document 1) Korean Patent No. 10-1843486

### DISCLOSURE

### Technical Problem

The present disclosure relates to an adhesive constructure for addressing the above-described problems in the art, and a method for manufacturing the same.

### Technical Solution

In view of the above, one embodiment of the present disclosure provides an adhesive constructure including: a substrate and a hollow structure disposed to protrude on the substrate, wherein the structure includes a hollow support portion protruding from the substrate and fixed on the substrate and an adhesive portion disposed below the hollow support portion and exposed to the outside, and the adhesive portion has a larger swelling ratio than the hollow support portion and the adhesive portion has a hollow horn shape of which volume expands in a wet state.

In the adhesive constructure, the hollow support portion may be filled with a material different from a material of the hollow support portion.

A through hole connected to the hollow support portion may be disposed in the substrate.

A pressure control means connected to the through hole and capable of controlling pressure inside the hollow structure may be further disposed on the other side surface opposite to the one side surface of the substrate on which the hollow structure is disposed.

The pressure control means may detach the adhesive portion from an object subject to adhesion by applying pressure.

The adhesive portion may be in a conformal contact with an object subject to adhesion to adhere to the object subject to adhesion.

A ratio of the swelling ratio of the adhesive portion with respect to the swelling ratio of the hollow support portion may be from 1.38 to 4.

A height of the hollow support portion may be 40% or greater and 80% or less with respect to a total height of the hollow structure.

An aspect ratio, which is a ratio of a height of the hollow structure with respect to a diameter of the hollow structure, may be from 0.5 to 6.

An elastic modulus of the adhesive portion may change by any one or more external stimuli of heat, light and pH.

The adhesive portion may include a swelling polymer hydrogel, may further include a pH-sensitive material, or may further include a temperature-sensitive material.

Another embodiment of the present disclosure provides a method for manufacturing an adhesive constructure, the method including: preparing a mold in which a groove for forming a hollow structure is formed; filling a certain portion of the groove of the mold with a first material and curing the result; additionally filling the groove of the mold with a second material having lower wettability than the first material; attaching a substrate so as to cover the groove of the mold and curing the result; and separating the hollow structure cured in the groove of the mold from the mold, wherein the cured first material forms an adhesive portion and the cured second material forms a hollow support portion, and the adhesive portion has a larger swelling ratio than the hollow support portion and the adhesive portion has a hollow horn shape of which volume expands in a wet state.

### Advantageous Effects

In an adhesive constructure according to one embodiment of the present disclosure, an adhesive portion has a hollow horn shape of which volume expands in a wet state, and therefore, the hollow horn-shaped structure has an outspread lower portion, and when attached to a substrate, adhesion with the substrate can be obtained as a contact area with the substrate increases.

In particular, when pulling the hollow horn-shaped structure for movement after the contact with the substrate, there is a pressure difference between inside and outside of the structure, increasing adhesion force. In addition, the adhesive constructure according to one embodiment of the present disclosure is capable of adhering to an object only through a conformal contact without applying suction pressure or negative pressure from the outside, and by applying slight pressure, the adhered object can be separated.

In addition, in the present disclosure, a material included in the adhesive portion having a hollow horn shape further includes a stimulus-responsive material that reacts by external stimuli such as heat, light and pH, allowing a change in the elastic modulus of the adhesive portion upon external stimuli, and as a result, stress used for stretching is larger than adhesion force, and detachment occurs spontaneously.

In addition, in the present disclosure, the adhesive constructure includes a hollow structure in which a hollow support portion and an adhesive portion are bound, and since the adhesive portion has a hollow horn shape, adhesion occurs even in a moist environment and detachment occurs by external stimuli, and transportation equipment can be provided by applying such an adhesive constructure.

### BRIEF DESCRIPTION OF DRAWINGS

FIG. 1 shows (a) a photograph of a starfish and a starfish arm having a tube foot, and an enlarged photograph thereof, (b) an enlarged view of a starfish arm having a tube foot, (c) sequential images of a starfish waking on a smooth glass surface, (d) high-speed sequential images showing a tube foot adhering to and separating from a glass substrate, (e) images of a starfish digging into sand to hide itself, and (f) high-speed images showing a tube foot picking up and dropping grains of sand.

FIG. 2 is a diagram illustrating an adhesive constructure according to one embodiment of the present disclosure.

FIG. 3 is a diagram illustrating a process of adhesion and detachment by a first example of an adhesive constructure according to one embodiment of the present disclosure.

FIG. 4 is a diagram illustrating a process of adhesion and detachment by a second example of an adhesive constructure according to one embodiment of the present disclosure.

FIG. 5 is a schematic process diagram illustrating a method for manufacturing an adhesive constructure according to another embodiment of the present disclosure.

FIG. 6 shows a schematic diagram of adhesive constructure manufacturing performed by partial curing of a first block and curing of a second block.

FIG. 7 shows (a) photographs of a cylinder constructure made of a non-swelling material (top), a cylinder constructure made of a swelling material (middle) and a double-layer cylinder constructure (bottom) before and after swelling in water, (b) a simulation result image of the double-layer cylinder constructure, and (c) images showing underwater adhesion of the cylinder constructures made of non-swelling (top) and swelling (middle) materials, and underwater adhesion of the double-layer cylinder constructure (bottom).

FIG. 8 shows (a) photographs of an adhesive constructure having a different swelling ratio of an adhesive portion (hydrogel block), (b) a pre-load force graph obtained when adhering an adhesive constructure having a different swelling ratio of an adhesive portion (hydrogel block) to a substrate, (c) an adhesion force graph and (d) an adhesion force graph of an adhesive constructure having a different swelling ratio when fixing a pre-load force value.

FIG. 9 shows (a) photographs of an adhesive constructure having a different fraction of an adhesive portion (hydrogel block) (scale bar: 5 mm), (b) a fraction-dependent pre-load force graph of an adhesive constructure having a different fraction of an adhesive portion (hydrogel block) and (c) an adhesion force graph.

FIG. 10 is a photograph showing an image of an experimental setup for measuring underwater adhesion.

FIG. 11 is a graph showing adhesion force of an adhesive constructure for various substrates.

FIG. 12 shows (a) photographs showing underwater adhesion of an adhesive constructure for an object having a weight and (b) images of golf ball adhesion by an arrangement of an adhesive constructure bound to a nitrile glove.

FIG. 13 shows (a) an image of an adhesive constructure having a different aspect ratio (scale bar: 5 mm), (b) photographs showing measurements of vertical adhesion force and shear adhesion force, (c) a vertical and shear adhesion force graph of an adhesive constructure having a different aspect ratio and (d) a graph showing a ratio of vertical adhesion force with respect to shear adhesion force of an adhesive constructure having a different aspect ratio.

FIG. 14 shows (a) a schematic diagram of adhesion/detachment capable of switching of an adhesive portion of an adhesive constructure made of a responsive hydrogel and photographs showing high adhesion force at a low temperature and weak adhesion force at a high temperature, and (b) photographs comparing adhesion force under light on and light off conditions.

FIG. 15 is a schematic diagram illustrating a process of adhesion and detachment of an adhesive constructure made of a responsive hydrogel controlled by light.

FIG. 16 shows photographs showing time-dependent changes in adhesion force of an adhesive constructure made of a responsive hydrogel controlled by light.

FIG. 17 shows (a) a schematic diagram illustrating a process of adhesion and detachment by a second example of an adhesive constructure according to one embodiment of the present disclosure and a photograph of the manufactured second example, and (b) photographs of picking up various objects and dropping these on a desired location using the second example.

### MODE FOR INVENTION

In the present specification, a description of a certain part “including” certain constituents means that it may further include other constituents, and does not exclude other constituents unless particularly stated on the contrary.

In the present specification, a description of a certain member being placed “on” another member includes not only a case of the certain member being in contact with the another member but a case of still another member being present between the two members.

In the present specification, terms “step to˜” and “step of˜” do not mean “step for˜”.

In the present specification, “adhesive” used in “adhesive portion” and “adhesive constructure” means physical adhesion for fixing an object or moving an object using vacuum.

Hereinafter, specific details for working of the present disclosure will be described in detail with reference to accompanying drawings.

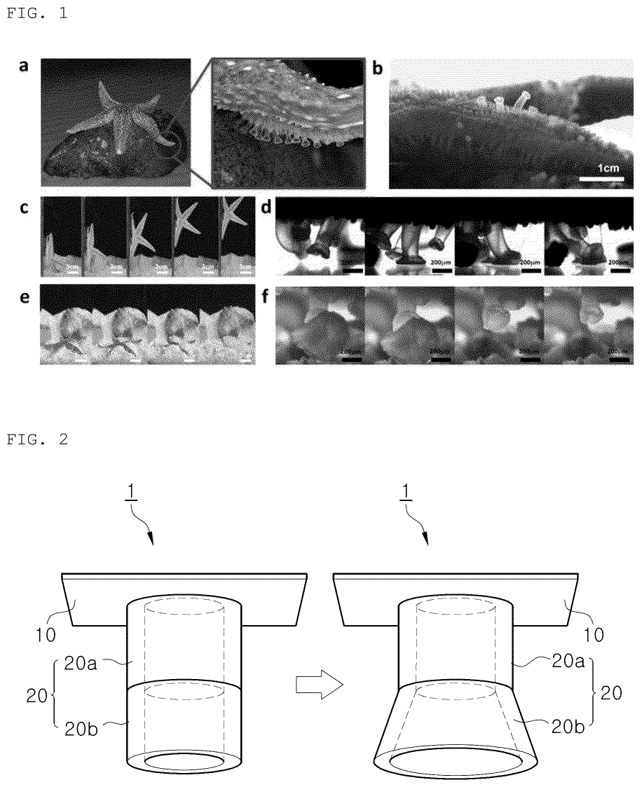

FIG. 1a shows a photograph of a starfish and a starfish arm having a tube foot, and an enlarged photograph thereof. FIG. 1b is an enlarged image of a starfish arm having a tube foot.

A tube foot of a starfish consists of a long and flexible tube-shaped body and a truncated cone-shaped protruding tip. This small and flexible tube foot helps starfishes move across rocks and catch food. In order to show the process, movement of a starfish walking in a glass bath is recorded using a high-speed camera in the present disclosure. FIG. 1c shows movement of a starfish climbing the wall of a glass container using its tube feet. Movement of a tube foot when a starfish steps on a glass wall to come off is shown in FIG. 1d.

When a starfish steps on a surface of a glass wall, the starfish pushes down a tip of its tube foot and spreads the tip of the tube foot to cover the surface. Through this process, the tip of the tube foot adheres on the surface. After that, the tube foot is tilted in a moving direction, and the tip of the adhered tube foot is separated from the surface by shear force corresponding thereto, causing the tube foot to come off from the glass wall.

In addition, in the present disclosure, a starfish digging into sand to hide its body is observed (FIG. 1e). To burrow into sand, a starfish sometimes carries sand grains using its tube foot. First, a tip of a tube foot spreads over a sand grain for adhesion. After that, the tube foot transports the sand to another location. The spread tip of the tube foot contracts to separate the sand from the tip of the tube foot, and drops the sand (FIG. 1f).

According to one embodiment of the present disclosure, an adhesive constructure made of two materials having different swelling characteristics is manufactured based on the above-mentioned underwater adhesion and detachment characteristics of a starfish.

FIG. 2 is a diagram illustrating an adhesive constructure according to one embodiment of the present disclosure.

The adhesive constructure 1 according to one embodiment of the present disclosure includes a substrate 10 and a hollow structure 20 disposed to protrude on the substrate 10, wherein the hollow structure 20 includes a hollow support portion 20a protruding from the substrate 10 and fixed on the substrate and an adhesive portion 20b disposed below the hollow support portion 20a and exposed to the outside, and the adhesive portion 20b has a larger swelling ratio than the hollow support portion 20a and the adhesive portion 20b has a hollow horn shape of which volume expands in a wet state.

The substrate 10 is not particularly limited, and for example, may be a substrate or a film. Specifically, the substrate 10 may be a glass substrate, a polyethylene terephthalate (PET) film or the like.

The hollow support portion 20a and the adhesive portion 20b may have a structure with hollow interior.

According to one embodiment of the present disclosure, the hollow support portion 20a may be made of a non-swelling material, and for example, may be made of a non-swelling polymer material. Specifically, the hollow support portion may be prepared from a photocurable composition including polyurethane acrylate (PUA) and 2-hydroxyethyl methacrylate (HEMA), however, the material is not limited thereto.

According to one embodiment of the present disclosure, the hollow support portion 20a may be filled with a material different from the material of the hollow support portion 20a.

Although the hollow support portion 20a is made of a non-swelling material, a problem of buckling of the hollow support portion 20a may occur during the process of pressurizing to adhere to an object subject to adhesion, and in order to prevent this phenomenon, the hollow support portion 20a may be filled with a material different from the material of the hollow support portion 20a. The material filled in the hollow support portion 20a is not particularly limited, and a material different from the material of the hollow support portion 20a may be used to prevent buckling.

When the hollow support portion 20a is filled with a material different from the material of the hollow support portion 20a, the problem of buckling does not occur when adhering the adhesive constructure, and an effect of minimizing the empty space of the hollow structure may be obtained, which increases changes in the internal volume during adhesion, leading to an effect of increasing adhesion force.

According to one embodiment of the present disclosure, the adhesive portion 20b may be made of a swelling material, and for example, may be made of a material including a swelling polymer hydrogel.

Specifically, according to one embodiment of the present disclosure, the hollow support portion 20a of the adhesive constructure 1 may be prepared from a mixture of polyurethane acrylate (PUA) and 2-hydroxyethyl methacrylate (HEMA). The adhesive portion 20b of the adhesive constructure 1 may be made of a poly (2-hydroxyethyl methacrylate-co-acrylamide) (HEMA-co-AAM) hydrogel.

According to one embodiment of the present disclosure, the adhesive portion 20b may have a larger swelling ratio than the hollow support portion 20a, and a ratio of the swelling ratio of the adhesive portion 20b with respect to the swelling ratio of the hollow support portion 20a may be from 1.38 to 4.

The ratio of the swelling ratio of the adhesive portion 20b with respect to the swelling ratio of the hollow support portion 20a may be from, for example, 1.38 to 3.5, 1.5 to 3.0, 1.6 to 2.5 or 1.7 to 2.0, and may be preferably from 1.38 to 1.8.

According to one embodiment of the present disclosure, after swelling, the adhesive portion 20b of the adhesive constructure 1 may be transformed into a hollow horn shape due to the difference in the swelling ratio between the hollow support portion 20a and the adhesive portion 20b.

For example, since the crosslinked PUA of the hollow support portion 20a does not absorb water molecules in a wet state, the swelling ratio of the hollow support portion 20a may be 119% under a wet condition.

On the other hand, the swelling ratio of the adhesive portion 20b may be from 150% to 400% due to interpenetration of water molecules within the swelling hydrogel network.

Herein, assuming that the cylinder diameter before the swelling of the hollow structure 20 having a double-layer cylinder structure is 100%, the swelling ratio of each of the hollow support portion 20a and the adhesive portion 20b may be defined as a value obtained by calculating a horizontally increased distance of the swollen hollow support portion 20a and adhesive portion 20b after swelling as % with respect to the diameter of the cylinder and adding the calculated result to 100% of the diameter of the cylinder.

In other words, the hollow support portion 20a having a swelling ratio of 119% means that, based on the cylinder diameter of the hollow support portion 20a in a dry state, the hollow support portion 20a is swollen by further increasing to the swollen other end area by 19% in a horizontal direction in a swelling state.

In addition, the adhesive portion 20b having a swelling ratio of 150% to 400% means that, based on the cylinder diameter of the adhesive portion 20b in a dry state, the lower end exposed to the outside of each position of the adhesive portion 20b is swollen by further increasing to the maximally swollen point by 50% to 300% in a horizontal direction in a swelling state.

According to one embodiment of the present disclosure, a ratio of the swelling ratio of the adhesive portion 20b with respect to the swelling ratio of the hollow support portion 20a may satisfy 1.38 to 4.

When the ratio of the swelling ratio of the adhesive portion 20b with respect to the swelling ratio of the hollow support portion 20a satisfies 1.38 to 4, adhesion/detachment of an object subject to adhesion may be freely controlled using the adhesive constructure 1, and excellent adhesion and detachment characteristics may be obtained.

When the ratio of the swelling ratio of the adhesive portion 20b with respect to the swelling ratio of the hollow support portion 20a is less than 1.38, the swelling ratio of the adhesive portion 20b is too small, and there may be a problem in that adhesion does not occur well when adhering to an object subject to adhesion, or excessive pressure needs to be applied for adhesion.

Meanwhile, when the ratio of the swelling ratio of the adhesive portion 20b with respect to the swelling ratio of the hollow support portion 20a is greater than 4, the swelling ratio of the adhesive portion 20b becomes too large, and the adhesive portion 20b readily expands when adhering to an object subject to adhesion, and pre-load force decreases since an entrance area of the adhesive portion 20b in contact with the object subject to adhesion increases. In this case, adhesion force of the adhesive constructure may decrease.

In addition, according to one embodiment of the present disclosure, the adhesive portion 20b may be swollen and transformed due to a difference in the volume expansion between layers as described above, and is swollen into a hollow horn shape.

The degree of swelling of the adhesive portion 20b is not large at an interface between the adhesive portion 20b and the hollow support portion 20a, and as the degree of swelling increases toward a downward direction of the adhesive portion 20b, the adhesive portion 20b has a hollow horn shape.

The hollow horn shape is not particularly limited, and for example, may be any one of a truncated cone, a truncated elliptic cone and a truncated pyramid. Preferably, the hollow horn shape may be a truncated cone shape.

In order to control the degree of swelling of the adhesive portion 20b, content and fraction of material components included in the adhesive portion 20b may be adjusted, and more specific details will be described later.

A height of the hollow support portion 20a may be 40% or greater and 80% or less with respect to the total height of the hollow structure 20.

When the height of the hollow support portion 20a satisfies 40% or greater and 80% or less with respect to the total height of the hollow structure 20, adhesion and detachment of an object subject to adhesion may be freely controlled using the adhesive constructure 1, and adhesion excellent and detachment characteristics may be obtained.

In particular, an adhesive constructure 1 capable of adhesion and detachment even in a humid environment or water may be provided.

When the height of the hollow support portion 20a is less than 40% with respect to the total height of the hollow structure 20, the height of the adhesive portion 20b is 60% or greater with respect to the total height of the hollow structure 20, and adhesion force may decrease since transforming force of the adhesive portion 20b increases.

On the other hand, when the height of the hollow support portion 20a is greater than 80% with respect to the total height of the hollow structure 20, the height of the adhesive portion 20b is too low and the adhesive portion may be readily separated by shear force.

An aspect ratio, a ratio of height with respect to diameter, of the hollow structure 20 may be from 0.5 to 6.

However, the aspect ratio, a ratio of height with respect to diameter, of the hollow structure 20 is not limited to 0.5 to 6, and may be from, for example, 0.5 to 5, 0.5 to 4, 0.8 to 3, 1 to 6 or 1 to 5, and may be preferably from 1 to 3.

Since the aspect ratio, a ratio of height with respect to diameter, of the hollow structure 20 satisfies 0.5 to 6, adhesion and detachment of an object subject to adhesion may be freely controlled using the adhesive constructure 1, and excellent adhesion and detachment characteristics may be obtained.

When the aspect ratio, a ratio of height with respect to diameter, of the hollow structure 20 is less than 0.5, the heights of the hollow support portion 20a and the adhesive portion 20b are not sufficiently secured, and adhesion and detachment performance may be reduced.

On the other hand, when the aspect ratio, a ratio of height with respect to diameter, of the hollow structure 20 is greater than 6, the height of the hollow structure 20 becomes excessively large, and accordingly, adhesion force may be reduced since transforming force of the adhesive portion 20b increases when the height of the adhesive portion 20b becomes large, and when the height of the hollow support portion 20a becomes large, the hollow support portion 20a may be readily separated by shear force.

An elastic modulus of the adhesive portion 20b may change by any one or more external stimuli of heat, light and pH.

The adhesive portion 20b includes a swelling polymer hydrogel and may further include a pH-sensitive material, or the adhesive portion 20b may further include a temperature-sensitive material.

The pH-sensitive material is not particularly limited, and any material of which elastic modulus changes when changing the pH by dropping an acid may be used. For example, the pH-sensitive material may be acrylic acid.

The temperature-sensitive material is not particularly limited, and any material of which elastic modulus changes when increasing a temperature by heating may be used. For example, the temperature-sensitive material may be NIPAAm (poly N-isopropylacrylamide).

The hollow support portion 20a and the adhesive portion 20b may have a structure with hollow interior, and due to the structural characteristics of the adhesive portion 20b having a hollow horn shape of which volume expands in a wet state, excellent adhesion and detachment performance may be achieved in a wet environment compared to existing adhesive constructures.

Specifically, since the adhesive portion 20b has a hollow horn shape of which volume expands in a wet state in the present disclosure, the adhesive portion 20b having a hollow horn shape spreads out in the lower portion, and when attached to a substrate, the contact area with the substrate increases, resulting in excellent adhesion force with the substrate.

In particular, when the hollow structure 20 of the adhesive constructure 1 according to one embodiment of the present disclosure is brought into contact with an object subject to adhesion such as a substrate and pulled for movement, a pressure difference occurs between inside and outside of the structure, resulting in an increase in the adhesion force.

In addition, since the adhesive portion 20b having a hollow horn shape is capable of changing an elastic modulus of the adhesive portion 20b when externally stimulated, stress used to stretch becomes larger than adhesion force, which may result in spontaneous detachment.

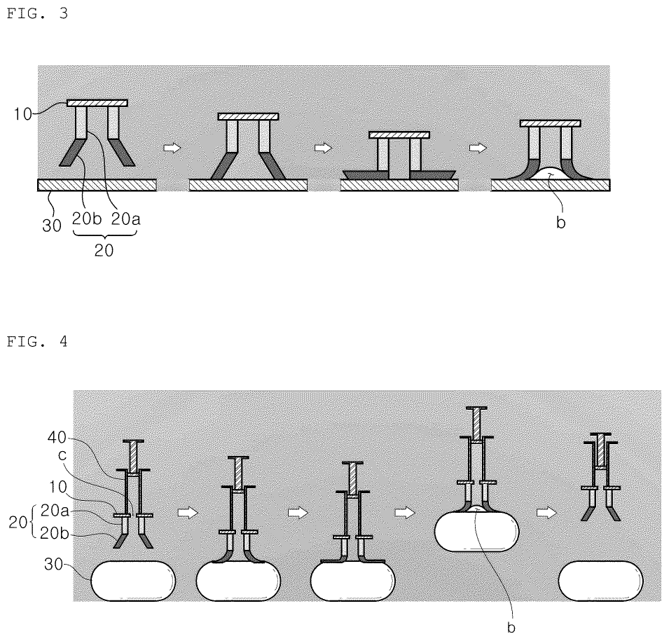

FIG. 3 is a diagram illustrating a process of adhesion and detachment by a first example of the adhesive constructure according to one embodiment of the present disclosure.

Referring to FIG. 3, the process of adhesion and detachment by a first example of the adhesive constructure according to one embodiment of the present disclosure is described as follows.

First, after swelling, the adhesive portion 20b of the adhesive constructure is disposed on an object subject to adhesion 30 in a state of being transformed into a hollow horn shape due to a difference in the swelling ratio between the hollow support portion 20a and the adhesive portion 20b. In particular, according to the first example of the present disclosure, the adhesive portion 20b of the adhesive constructure has a hollow truncated cone shape.

Next, the adhesive portion 20b transformed into a hollow truncated cone shape in the adhesive constructure is brought into contact with the object subject to adhesion 30.

Then, the adhesive portion 20b in contact with the object subject to adhesion 30 adheres to the object subject to adhesion 30 while being compressed to a horizontal state.

Then, when pulling back the adhesive portion 20b in the process of lifting the adhesive constructure 1, the adhesive portion 20b strongly adheres to the object subject to adhesion 30 as bubbles (b) are formed inside due to a cavity effect caused by a sudden change in the pressure. In other words, when pulling back the adhesive portion 20b, solubility of air for water decreases as the pressure inside the adhesive constructure 1 is reduced, and the adhesive portion 20b may strongly adhere to the object subject to adhesion 30 as bubbles (b) are formed inside the adhesive constructure 1.

After that, when additionally applying pulling force, the shape of the adhesive portion 20b is transformed, releasing water inside the adhesive constructure 1, and the object subject to adhesion 30 may be detached.

The object subject to adhesion 30 may be a substrate such as a silicon wafer, an acrylic board or slide glass, or a soft or hard object having various shapes, but is not limited thereto. FIG. 4 is a diagram illustrating a process of adhesion and detachment by a second example of the adhesive constructure according to one embodiment of the present disclosure.

According to the second example of the adhesive constructure according to one embodiment of the present disclosure, a through hole (c) connected to the hollow support portion 20a may be disposed in the substrate 10.

On the other side surface opposite to the one side surface of the substrate 10 on which the hollow structure 20 is disposed, a pressure control means 40 connected to the through hole (c) and capable of controlling a pressure inside the hollow structure 20 may be further disposed.

The pressure control means 40 is not particularly limited, and any device or means capable of applying or reducing pressure may be used without limit, and as in one example of the present disclosure, a syringe, a dropper or the like may be used.

In other words, the pressure control means 40 may detach the adhesive portion 20b from the object subject to adhesion 30 by applying pressure.

Meanwhile, the pressure control means 40 may adhere the adhesive portion 20b to the object subject to adhesion 30 by reducing pressure.

In the second example of the adhesive constructure according to one embodiment of the present disclosure, the adhesive portion 20b transformed into a hollow truncated cone shape is capable of adhering to and detaching from the object subject to adhesion 30 as in the first example.

Specifically, in the second example of the present disclosure, the adhesive portion 20b transformed into a hollow truncated cone shape in the adhesive constructure 1 is brought into contact with the object subject to adhesion 30, and as the adhesive portion 20b brought into contact with the object subject to adhesion 30 is compressed to a horizontal state, the adhesive portion 20b adheres to the object subject to adhesion 30.

After that, the adhesive portion 20b releases water inside the adhesive constructure 1 and is capable of detaching the object subject to adhesion 30 as it is transformed in the shape, and in the second example of the present disclosure, the adhesive portion 20b may be quickly detached from the object subject to adhesion 30 when applying pressure using the pressure control means 40.

In other words, when performing adhesion and detachment according to the second example of the present disclosure, control of quick adhesion and detachment switching is possible by the pressure control means 40.

Meanwhile, according to one embodiment of the present disclosure, the adhesive portion 20b may be in a conformal contact with an object subject to adhesion 30 under water to adhere to the object subject to adhesion.

The adhesive constructure 1 according to one embodiment of the present disclosure is capable of adhering to an object only through a conformal contact without applying suction pressure or negative pressure from the outside, and by applying slight pressure, the adhered object may be separated.

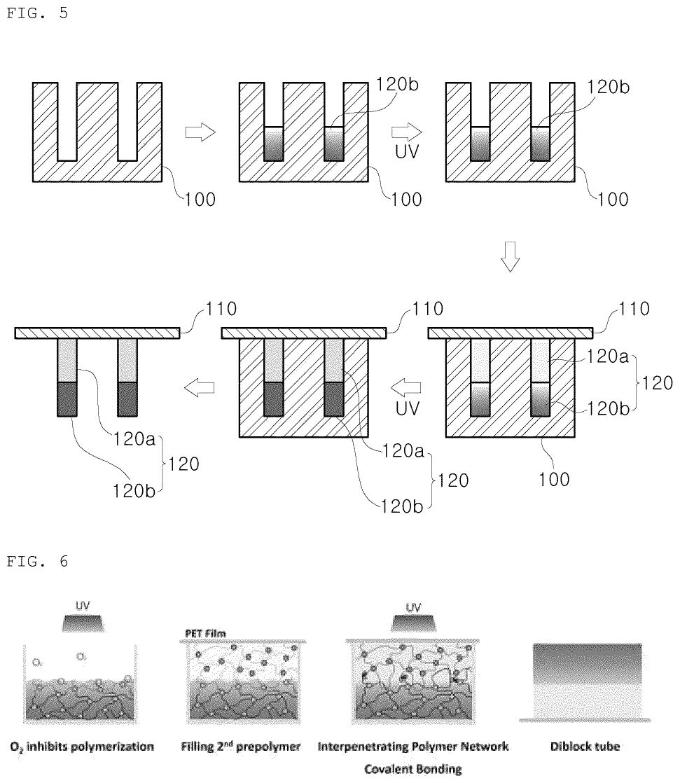

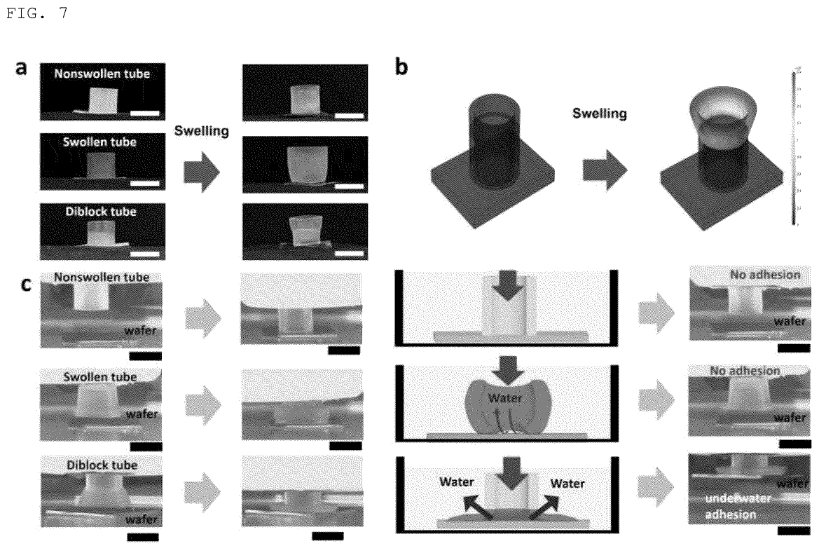

FIG. 5 is a schematic process diagram illustrating a method for manufacturing an adhesive constructure according to another embodiment of the present disclosure.

FIG. 6 shows a schematic diagram of adhesive constructure manufacturing performed by partial curing of a first block and curing of a second block.

Referring to FIG. 5 and FIG. 6, the method for manufacturing an adhesive constructure according to another embodiment of the present disclosure includes: preparing a mold 100 in which a groove for forming a hollow structure is formed; filling a certain portion of the groove of the mold 100 with a first material and curing the result; additionally filling the groove of the mold 100 with a second material having lower wettability than the first material; attaching a substrate 110 so as to cover the groove of the mold 100 and curing the result; and separating the hollow structure 120 cured in the groove of the mold 100 from the mold 100, wherein the cured first material forms an adhesive portion 120b and the cured second material forms a hollow support portion 120a, and the adhesive portion 120b has a larger swelling ratio than the hollow support portion 120a and the adhesive portion 120b has a hollow horn shape of which volume expands in a wet state.

In the step of filling a certain portion of the groove of the mold with a first material and curing the result, the first material may be partially cured with a portion exposed to the outside of the first material in an uncured state.

In addition, in the step of additionally filling the groove of the mold with a second material having lower wettability than the first material, the first material and the second material are mixed with each other by diffusion at an interface where each layer is in contact with each other, and a network may be formed through the curing.

In another embodiment of the present disclosure, a constructure with hollow interior is formed first, and then a step of preparing a groove-formed engraved silicon mold 100 using the constructure with hollow interior is performed.

Then, the step of filling a certain portion of the groove of the mold 100 with a first material and curing the result is performed.

In the process, for example, the groove may be filled with a mixture of hydrogel and ethanol, and after all the ethanol is dried, the groove may be filled with a hydrogel prepolymer to a desired height. Then, the hydrogel prepolymer is partially cured while exposing the surface to air.

In other words, the step of filling a certain portion of the groove of the mold 100 with a first material and curing the result is performed by the above-described process, and the height of the hydrogel inside the mold 100 may be controlled by adjusting the volume percent of ethanol in the mixture.

Next, the step of additionally filling the groove of the mold 100 with a second material having lower wettability than the first material, the step of attaching a substrate 110 so as to cover the groove of the mold and curing the result, and the step of separating the hollow structure 120 cured in the groove of the mold 100 from the mold are performed.

In the step of additionally filling the groove of the mold 100 with a second material having lower wettability than the first material and the step of attaching a substrate so as to cover the groove of the mold and curing the result, a process of, for example, pouring a second prepolymer for the support portion (non-swollen layer) into the hydrogel that is the partially cured (due to oxygen suppression) first material and then covering the result with a polyethylene terephthalate (PET) film is performed. The hydrogel prepolymer that is the first material not cured on the surface and the second prepolymer that is the second material may be mixed by diffusion at an interface of each layer, and a network may be formed through the curing. The two prepolymers bind while the prepolymers are coagulated, and a HEMA monomer included in the first hydrogel prepolymer facilitates binding of the two prepolymers (FIG. 6).

Hereinafter, the present disclosure will be described in detail with reference to examples in order to specifically describe the present disclosure. However, examples according to the present disclosure may be modified to various different forms, and the scope of the present disclosure is not construed as being limited to the examples described below. Examples of the present specification are provided in order to more fully describe the present disclosure to those having average knowledge in the art.

### EXAMPLE

### Preparation of Poly (2-hydroxyethyl methacrylate-co-acrylamide) (HEMA-co-AAM) Swelling Hydrogel

A swelling hydrogel was prepared by mixing acrylamide (Sigma, A8887) and 2-hydroxyethyl methacrylate (Sigma, 128635) as monomers, N, N-methylenebisacrylamide (MBAA; Sigma, M7279) as a crosslinking agent, and 2-hydroxy-2-methylpropiophenone (Darocur 1173; Sigma) as a photoinitiator. In a glass bottle, 6.44 g of HEMA, and, with respect to 100% by weight of the HEMA, 0.42% by weight of MBAA, 4.57% by weight of Darocur 1173 and, in order to adjust the swelling ratio of the hydrogel, 1.86% by weight to 18.64% by weight of acrylamide (AAm) were mixed. In order to improve toughness of the hydrogel, linear polymerization was performed first with HEMA, acrylamide (AAm) and photoinitiator, and then the result was mixed with monomers of HEMA, acrylamide (AAm) and MBAA (crosslinking agent). After that, the mixture was stirred for 1 hour using a magnetic stirrer.

### Preparation of Poly (2-hydroxyethyl methacrylate-co-polyurethane acrylate) (HEMA-co-PUA) Non-Swelling Polymer

A non-swelling polymer was prepared by mixing a monomer of 2-hydroxyethyl methacrylate (Sigma, 128635) and a PUA prepolymer (PUM301, MCnet) in a weight ratio of 1:1. The mixture was stirred for 1 hour using a magnetic stirrer.

### Preparation of Poly (2-hydroxyethyl methacrylate-co-N-isopropylacrylamide) (HEMA-co-NIPAM) Thermo-Responsive Hydrogel

A thermo-responsive hydrogel was prepared by mixing 2-hydroxyethyl methacrylate (Sigma, 128635) and N-isopropylacrylamide (NIPAm; Sigma, 415324) as monomers, N, N-methylenebisacrylamide (Sigma, M7279) as a crosslinking agent, and 2-hydroxy-2-methylpropiophenone (Sigma) as a photoinitiator. 3.22 g of HEMA, and, with respect to 100% by weight of the HEMA, 0. 67% by weight of MBAA (crosslinking agent), 3.67% by weight of Darocur 1173 and 22.7% by weight of NIPAAm were mixed in a glass bottle. The mixture was stirred overnight using a magnetic stirrer.

### Preparation of Photo-Responsive Hydrogel

A photo-responsive hydrogel was prepared by mixing HEMA-co-NIPAm and graphene oxide as a photothermal material. Graphene oxide (GO) dispersed in HO was mixed with the hydrogel (4 mg/ml, dispersed in H₂O, Sigma 777676). To the prepared HEMA-co-NIPAm hydrogel, dispersed graphene oxide (150 μL) was added, and the mixture was magnetically stirred for 1 hour.

### Preparation of Replica Mold for Manufacturing Adhesive Constructure

First, a hollow structure was prepared by 3D printing using a commercially available digital light processing (DLP) 3D printer (Litho, Illumenade Co., Ltd.). After that, a soft template was prepared using EcoFlex (EcoFlex™ 0030, Smooth-on). Part A and Part B of the EcoFlex prepolymer were mixed in a weight ratio of 1:1.

The mixture was poured onto the master printed using a 3D printer. After crosslinking for 4 hours or longer at 60° C., the EcoFlex replica mold was peeled off from the master.

### Manufacture of Adhesive Constructure

First, a mixture of a photoinitiator and the swelling polymer hydrogel was prepared in order to prepare a swollen cylinder. The prepared mold (Ecoflex) was partially filled with the mixed prepolymer. Then, the samples were exposed to ultraviolet light for partial curing. The surface of the prepolymer was exposed to air to suppress curing by oxygen. Subsequently, the remaining volume area of the mold was filled with the non-swelling prepolymer (HEMA-co-PUA), and the liquid prepolymer was covered with PET to prevent oxygen diffusion and exposure to ultraviolet light for 2 minutes. The structure attached to the PET film was cured with UV to completely cure the uncured prepolymer, and then separated from the Ecoflex mold.

### Experimental Example

In order to examine advantages of underwater adhesion of the adhesive constructure, a cylinder constructure was prepared with a single material (non-swelling polymer and swelling hydrogel), and underwater adhesion force was compared.

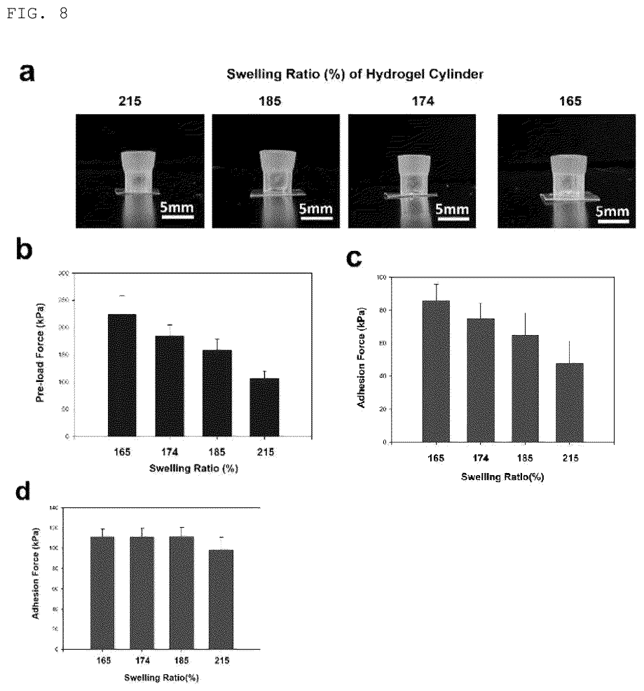

FIG. 7a shows shape transformation of various cylinder constructures before and after immersion in water. In order to differentiate the swelling area, the swelling hydrogel and a color dye were mixed. The photograph on the left shows the straight cylinder constructure before being placed in water, and the photograph on the right shows the cylinder constructure after swelling in water for 24 hours. The cylinder constructure made of a non-swelling polymer does not absorb water. Accordingly, the cylinder constructure maintained its original shape after swelling (top of FIG. 7a). The entire cylinder constructure made of a swelling hydrogel was swollen due to volume expansion caused by absorption of water molecules in the swelling hydrogel network (middle of FIG. 7a). On the other hand, the double-layer cylinder constructure has a different degree of swelling, and whereas the upper portion is swollen more, swelling of the region from the interface to the lower portion is limited by the non-swollen lower portion (bottom of FIG. 7a). FIG. 7b shows a finite element method (FEM) simulation of the double-layer cylinder constructure transformation having results similar to the experimental data. The adhesive portion of the adhesive constructure may have a wider entrance area than the hollow support portion.

In order to compare underwater adhesion force of the single material constructure and the double-layer cylinder constructure, a silicon wafer was placed in a water bath, and after adhering three constructures with different cylinder shapes thereto, an attempt to lift the wafer was made.

FIG. 7c shows images of the experiment. As for the non-swollen single cylinder, there was no underwater adhesion to the wafer (top of FIG. 7c). The swelling hydrogel cylinder-shaped constructure became soft and flexible in water, however, the swelling hydrogel cylinder-shaped constructure bent while applying pressure to the wafer. Accordingly, the swelling hydrogel cylinder-shaped cylinder constructure was not able to adhere to the wafer (middle of FIG. 7c). In order to identify adhesion defects of a linear constructure, an experiment to adhere with a constructure made of a soft material (PDMS and Ecoflex) was attempted. The cylinder constructure made of a single hydrogel, that is, the soft and linear constructure was buckled, which is the same as not adhering to the wafer. However, the adhesive constructure according to one embodiment of the present disclosure adhering to a silicon wafer lifted the wafer from the water bath. When applying pressure to the silicon wafer from the adhesive constructure, the entrance of the adhesive constructure spread over the silicon wafer, forming vacuum between the adhesive portion and the wafer.

Next, in order to examine the effect of the adhesive constructure on underwater adhesion depending on the adhesive constructure design, adhesive constructures were prepared so that the adhesive portion (hydrogel block) has various swelling ratios and fractions.

The fraction of the adhesive portion (hydrogel block) may be defined as a ratio of the height of the adhesive portion (hydrogel block) with respect to the total height of the hollow structure including the adhesive portion (hydrogel block) and the hollow support portion (non-swollen block).

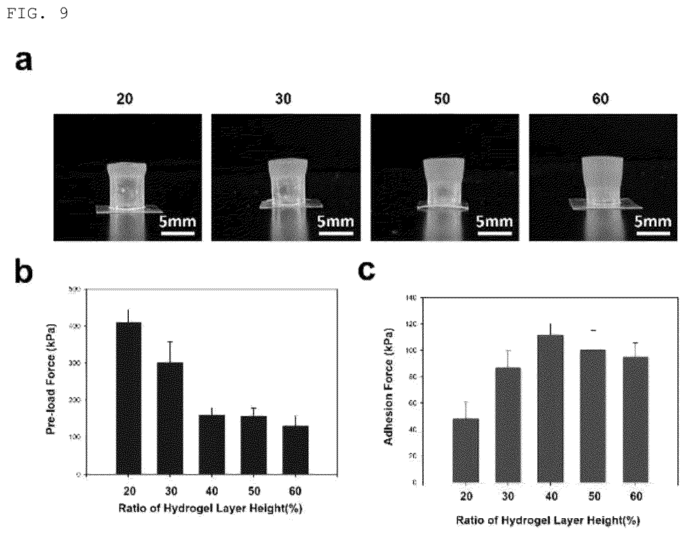

FIG. 8a shows photographs of the adhesive constructure having different swelling ratios. In order to control the swelling ratio, the fraction of acrylamide (AAM) was adjusted with HEMA. As the swelling ratio increased, the fraction of the adhesive portion (hydrogel block) increased compared to that of the hollow support portion (non-swollen block) located below the adhesive portion (FIG. 8a).

FIG. 8b shows pre-load force required to expand on an acrylic board for the adhesive constructure having different swelling ratios measured by a load cell in water. In all cases, the fraction of the swollen adhesive portion (hydrogel block) was fixed at 40%. The adhesive portion readily expanded as the swelling ratio increased, and the entrance area of the adhesive portion in contact with the substrate increased, reducing pre-load force.

FIG. 8c shows pre-load force-dependent adhesion force of the double-layer cylinder constructure having different swelling ratios.

The decrease in the pre-load force reduced adhesion force, and when lifting, the adhesive portion (hydrogel block) of the adhesive constructure was separated.

Referring to FIG. 8d, it shows that, when fixing the pre-load force at 450 kPa to 550 kPa, the adhesion force was not affected by the swelling ratio.

FIG. 9a shows photographs of the adhesive constructure having different fractions of the adhesive portion (hydrogel block). In the present disclosure, the swelling ratio of the adhesive portion was fixed at 185% based on a dry state.

FIG. 9b is a graph showing pre-load force of the adhesive portion (hydrogel block) having different fractions. It shows that pre-load force decreased as the fraction of the adhesive portion (hydrogel block) increased. As the fraction of the adhesive portion (hydrogel block) increased, the flexible hydrogel occupied more, and the adhesive portion (hydrogel block) was able to expand even with reduced pressure. Accordingly, the pressure actually felt by the entrance of the adhesive portion (hydrogel block) decreases, and pre-load force for adhesion may decrease.

FIG. 9c shows adhesion force of the adhesive portion (hydrogel block) having different fractions when fixing the pre-load force at 450 kPa to 550 kPa. As shown in FIG. 9c, the contact area between the adhesive portion and the substrate increased as the fraction or mass of the adhesive portion (hydrogel block) increased, and therefore, adhesion force increased. This trend showed up to a fraction of 40% as shown in FIG. 9c, however, when the fraction of the adhesive portion (hydrogel block) increased beyond 40%, adhesion force decreased. As the proportion of the adhesive portion (hydrogel block) increased, more buckling occurred during compression, and such buckling caused an uneven contact area along the entrance edge of the adhesive portion (hydrogel block), and such unevenness of the area increased as the fraction of the adhesive portion (hydrogel block) increased.

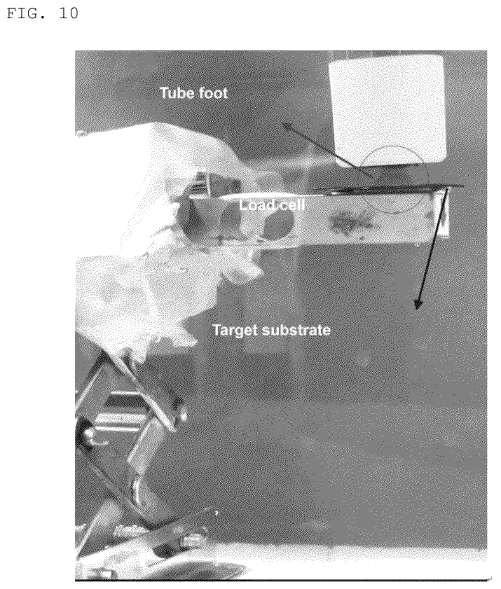

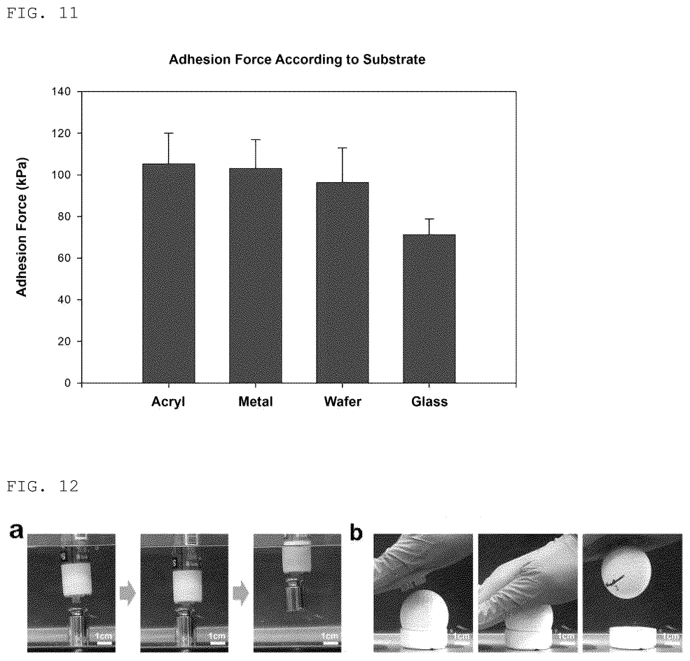

Then, underwater adhesion force of the adhesive constructure was measured using custom-made equipment (FIG. 10). After immersing the equipment in a water bath, adhesion force was measured using a load cell-bound target substrate such as a silicon wafer, an acrylic board or slide glass. The hollow structure including the hydrogel block with a different fraction was swollen in water for 1 hour at room temperature (˜20° C.). Pressure was applied (pre-load force) from the adhesive constructure to the load cell-bound target substrate until the adhesive constructure adhered to the substrate. After adhering the adhesive constructure, the constructure was pulled in a vertical direction and separated, and adhesion force was measured. Adhesion force was determined to be about 103.1 kPa for a metal substrate, about 96.3 kPa for a silicon wafer, and about 71.4 kPa for a glass substrate (FIG. 11). Adhesion force was higher at 111.6 kPa on a surface of an acrylic board.

Next, an underwater adhesion ability of the adhesive constructure (swelling ratio 185%, adhesive portion (hydrogel block) fraction 40%) was identified. In the present disclosure, an ability to pick up an object in water was tested first. FIG. 12a shows that the adhesive portion of the adhesive constructure is capable of lifting an object weighing 100 g in water. In another test, an ability of the adhesive portion of the adhesive constructure to grip an object having a rough curve was evaluated. FIG. 12b shows arrangements of the adhesive constructures bound to a nitrile glove while picking up a golf ball.

In addition, an effect of an aspect ratio of the adhesive constructure was examined in the present disclosure.

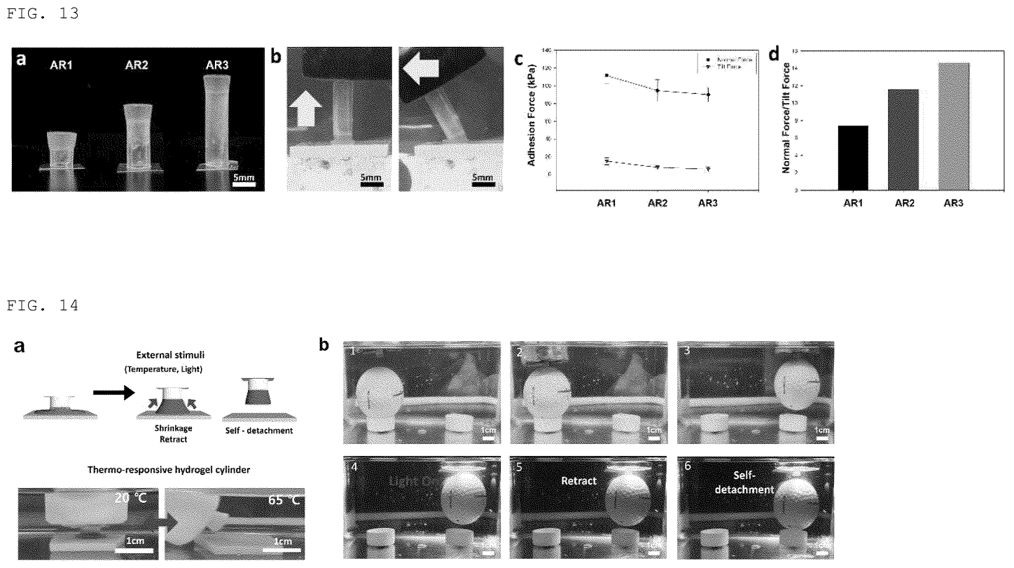

Three adhesive constructures with different heights (h=5 mm, 10 mm, 15 mm, d=5 mm) were prepared. The height of the swollen hydrogel block (adhesive portion) of all the hollow structures was fixed at 2 mm, and the hollow support portion was made of a non-swollen block and filled with HEMA in order to prevent buckling (FIG. 13a).

After adhering the adhesive constructure to an acrylic substrate, the adhesive constructure was pulled in a direction perpendicular and parallel to the acrylic substrate to measure vertical adhesion force and shear adhesion force of the adhesive constructure (FIG. 13b). As shown in FIG. 13c, vertical adhesion force decreased as the aspect ratio increased, and this is due to the fact that, as the volume of water inside the adhesive constructure increased, air was released as the adhesive constructure was pulled back. In addition, shear adhesion force decreased when the aspect ratio increased from 1 to 3.

FIG. 13d shows a ratio of vertical adhesion force with respect to shear adhesion force. The ratio of vertical adhesion force with respect to shear adhesion force of the 15 mm adhesive constructure (aspect ratio=3) was twice or more the ratio of the 5 mm adhesive constructure (aspect ratio=1). From this result, it can be seen that the adhesive constructure having a long non-swollen block, a hollow support portion, has similar vertical adhesion force to the adhesive constructure having a short hollow support portion, but, by having small shear adhesion force, is more readily separated by shear force compared to the adhesive constructure having a short hollow support portion.

An advantage of the present disclosure is manufacturing an adhesive constructure using a hydrogel responding to external stimuli, allowing the adhesive constructure to be operated by external stimuli.

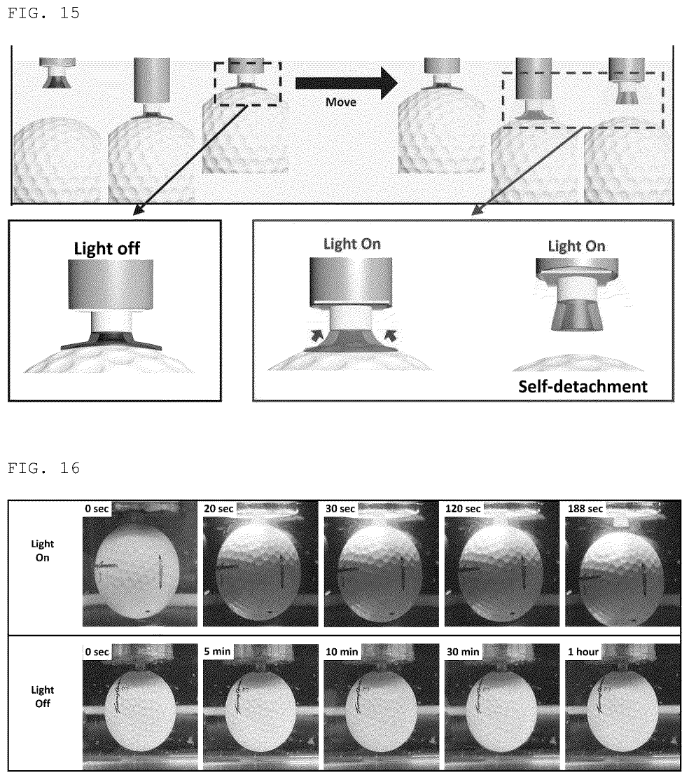

FIG. 14a is a schematic diagram of responsive adhesion identified by using an adhesive portion of an adhesive constructure that responds to stimulation. The function of responsive adhesion is illustrated in FIG. 14a. Components responding to external stimuli such as heat or light were added to a hydrogel for forming an adhesive portion. The adhesive portion including components responding to external stimuli (adhesive portion including responsive hydrogel) shrinks from the adhered surface when operated by the external stimuli, eventually separating on its own. Through this function, adhesion and detachment obtainable with the adhesive constructure may be switched and controlled. Underwater adhesion capable of switching between adhesion and detachment may be achieved by adding a temperature-activated component to the hydrogel. For this purpose, poly(poly(N-isopropylacrylamide) (PNIPAm) swelling at a low temperature and shrinking at a high temperature was used. For visualization, a thermo-responsive dye (thermochromic temperature activated pigment powder, Amazon.com) was added thereto. This dye was blue at a low temperature and white at a high temperature. As shown in FIG. 14a, the adhesive constructure having a blue adhesive portion firmly adhered to the acrylic board in water at 25° C. When this adhesive constructure is placed in water at 65° C., the adhesive portion (hydrogel block) shrinks in response to the temperature, and as the adhesive portion turned white, the contact with the acrylic board was lost, and the acrylic board fell.

In the present disclosure, a device in which the adhesive constructure was bound to a glass bottle having a halogen lamp (Halostar 50 W 12V GY6. 35, Osram) therein was prepared. A photothermal material (graphene oxide) was mixed with PNIPAm so that light inside the adhesive portion (hydrogel block) is able to be converted into thermal energy. FIG. 14b shows temporary and controllable adhesion performance for an object by moving the object to another location through binding without light and then turning the light on to heat the adhesive portion (hydrogel block) and turn it back to its original shape.

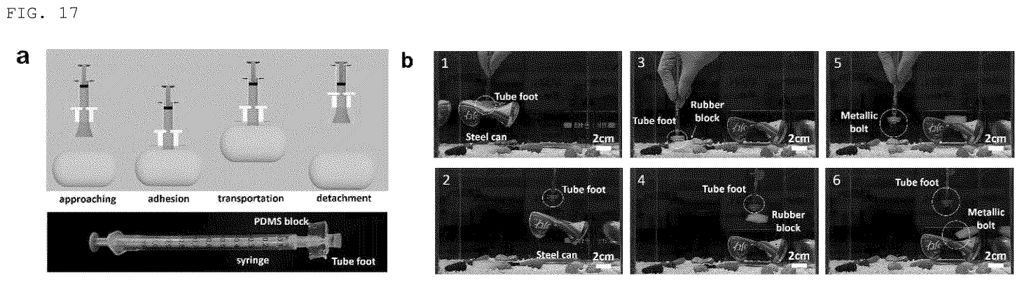

The first line shows the device picking up a golf ball in water and moving the ball to another location (1 to 3 of FIG. 14b). The second line shows that the ball falls out of the adhesive portion (hydrogel block) when the light is on, and is placed on a desired location, completing the transport of the golf ball (4 to 6 of FIG. 14b). Light increased the temperature of the adhesive portion (hydrogel block), and such an increase in the temperature caused the hydrogel to shrink, eventually detaching the ball. Such light-controlled movement of the golf ball is illustrated in FIG. 15. In particular, the adhesive portion (hydrogel block) detached the object bound to the adhesive portion in 3 minutes with the light on, but held the object for 1 hour or longer with the light off (FIG. 16).

For high adhesion and detachment switching speed in underwater transport, a unique function of an adhesive constructure was utilized. In the present disclosure, a simple device of the adhesive constructure connected to a syringe was made according to the second example (FIG. 17a). Since the double-layer cylinder structure proposed in the present disclosure was bonded on a thin PET film, a through hole connecting the syringe to an internal space of the double-layer cylinder structure through the film was able to be made. A perforated rubber (PDMS) substrate was used to connect the double-layer cylinder structure to the syringe. Then, outside of the device was sealed. In other words, a UV curable polymer was coated on the double-layer cylinder structure-PDMS substrate-syringe to prevent water leakage inside the device. In this case, the double-layer cylinder structure for adhesion was filled with incompressible water, and there was no need to apply negative pressure. After binding an object, the object was moved, and the adhesive constructure was able to drop the object by applying slight pressure to the syringe. In the present disclosure, an attempt to transport a steel can, a soft rubber block and a metal bolt was made to pick up the objects and drop them on a desired location (FIG. 17b).

In the present disclosure, the effect of swelling ratio and more swelling ratios were studied in order to find an optimal underwater adhesion condition. Due to the high aspect ratio characteristics, the adhesive constructure according to one embodiment of the present disclosure exhibited high ratio of vertical adhesion force with respect to shear adhesion force, facilitated detachment by sheer force, and high adhesion force by vertical adhesion force. The more swollen adhesive portion was made of stimuli-responsive materials, and adhesion force was controlled by heat, light and pH. The temporary and highly responsive underwater adhesion mechanism according to the present disclosure may be used in various application fields such as underwater robotics or biomedical application fields.

The present disclosure described above is not limited to the above-described examples, since various substitutions and changes may be made by those skilled in the art within the scope of not departing from technical ideas of the present disclosure.

### REFERENCE NUMERAL

1: Adhesive constructure
10, 110: Substrate
20, 120: Hollow structure
20a, 120a: Hollow support portion
20b, 120b: Adhesive portion
30: Object subject to adhesion
40: Pressure control means
100: Mold

1. An adhesive constructure comprising:
a substrate; and
a hollow structure disposed to protrude on the substrate,
wherein the structure includes,
a hollow support portion protruding from the substrate and fixed on the substrate; and
an adhesive portion disposed below the hollow support portion and exposed to the outside, and
the adhesive portion has a larger swelling ratio than the hollow support portion, and the adhesive portion has a hollow horn shape of which volume expands in a wet state.

2. The adhesive constructure of claim 1, wherein the hollow support portion is filled with a material different from a material of the hollow support portion.

3. The adhesive constructure of claim 1, wherein a through hole connected to the hollow support portion is disposed in the substrate.

4. The adhesive constructure of claim 3, wherein a pressure control means connected to the through hole and capable of controlling pressure inside the hollow structure is further disposed on the other side surface opposite to the one side surface of the substrate on which the hollow structure is disposed.

5. The adhesive constructure of claim 4, wherein the pressure control means detaches the adhesive portion from an object subject to adhesion by applying pressure.

6. The adhesive constructure of claim 1, wherein the adhesive portion is in a conformal contact with an object subject to adhesion to adhere to the object subject to adhesion.

7. The adhesive constructure of claim 1, wherein a ratio of the swelling ratio of the adhesive portion with respect to the swelling ratio of the hollow support portion is from 1.38 to 4.

8. The adhesive constructure of claim 1, wherein a height of the hollow support portion is 40% or greater and 80% or less with respect to a total height of the hollow structure.

9. The adhesive constructure of claim 1, wherein an aspect ratio, which is a ratio of a height of the hollow structure with respect to a diameter of the hollow structure, is from 0.5 to 6.

10. The adhesive constructure of claim 1, wherein an elastic modulus of the adhesive portion changes by any one or more external stimuli of heat, light and pH.

11. The adhesive constructure of claim 1, wherein the adhesive portion includes a swelling polymer hydrogel.

12. The adhesive constructure of claim 11, wherein the adhesive portion further includes a pH-sensitive material.

13. The adhesive constructure of claim 11, wherein the adhesive portion further includes a temperature-sensitive material.

14. A method for manufacturing an adhesive constructure, the method comprising:
preparing a mold in which a groove for forming a hollow structure is formed;
filling a certain portion of the groove of the mold with a first material and curing the result;
additionally filling the groove of the mold with a second material having lower wettability than the first material;
attaching a substrate so as to cover the groove of the mold and curing the result; and
separating the hollow structure cured in the groove of the mold from the mold,
wherein the cured first material forms an adhesive portion, and the cured second material forms a hollow support portion, and
the adhesive portion has a larger swelling ratio than the hollow support portion, and the adhesive portion has a hollow horn shape of which volume expands in a wet state.

15. The method of claim 14, wherein, in the filling of a certain portion of the groove of the mold with a first material and curing the result, a portion of the first material exposed to the outside is in an uncured state.

16. The method of claim 14, wherein, in the additionally filling of the groove of the mold with a second material having lower wettability than the first material, the first material and the second material are mixed with each other by diffusion at an interface where each layer is in contact with each other, and a network is formed through the curing.
